(19) United States
(12) Patent Application Publication
(10) Pub. No.: US 2003/0202362 A1
(43) Pub. Date: Oct. 30, 2003

(54) Light emitting golf ball

(76) Inventor: Hsueh-Yen Liou, Taichung (TW)

Correspondence Address: ROSENBERG, KLEIN & LEE, 3458 ELLICOTT CENTER DRIVE-SUITE 101, ELLICOTT CITY, MD, 21043, US

(21) Appl. No.: 10/128,273

(22) Filed: Apr. 24, 2002

(51) Int. Cl. F21L 4/00

(52) U.S. Cl. 362/555; 362/102; 362/184; 362/276; 362/800

(57) ABSTRACT

A light emitting golf ball is constructed to include a plastic outer shell that admits light, a plastic core embedded in the outer shell, the plastic core admitting light, and a light emitting circuit assembly embedded in the core, the light emitting circuit assembly including a battery, a plurality of LEDs, and an impact switch electrically connected between the battery and the LEDs and adapted to turn on the LEDs upon an impact.

### BACKGROUND OF THE INVENTION

1. Field of the Invention

The present invention relates to golf balls and, more particularly, to a light emitting golf ball adapted for use in the night, which emits light when driven into the air.

2. Description of the Related Art

Conventional golf balls do not emit light. When playing golf in the night, the player cannot accurately estimate the direction and amount of the flying of the golf ball under limited illumination of field lamps. When the golf ball was driven into the rough, water hazard, or any dark place in the course, the player may have to spend a lot of time finding the ball.

### SUMMARY OF THE INVENTION

The present invention has been accomplished under the circumstances in view. It is the main object of the present invention to provide a light emitting golf ball, which is practical for playing in the night. It is another object of the present invention to provide a light emitting golf ball, which emits light only when driven into the air by a golf club. To achieve these and other objects of the present invention and according to one aspect of the present invention, the light emitting golf ball comprises a plastic outer shell that admits light, a plastic core embedded in the outer shell, the plastic core admitting light, and a light emitting circuit assembly embedded in the core. The light emitting circuit assembly comprises a battery, a plurality of LEDs, and an impact switch electrically connected between the battery and the LEDs and adapted to turn on the LEDs upon an impact. According to another aspect of the present invention, the light emitting circuit assembly is provided with a control IC adapted to control the flash mode of the LEDs subject to the control of the impact switch.

### BRIEF DESCRIPTION OF THE DRAWINGS

FIG. 1A illustrates a light emitting circuit assembly embedded in a spherical core according to the present invention.

FIG. 1B is a perspective view of a light emitting golf ball according to the present invention.

FIG. 2 is a sectional view of the light emitting golf ball present invention according to the present invention, showing the LEDs switched on.

FIG. 3 is a sectional view of the light emitting circuit assembly for the light emitting golf ball according to the present invention, showing the LEDs switched on.

FIG. 4 is a circuit diagram of the light emitting circuit assembly according to the present invention.

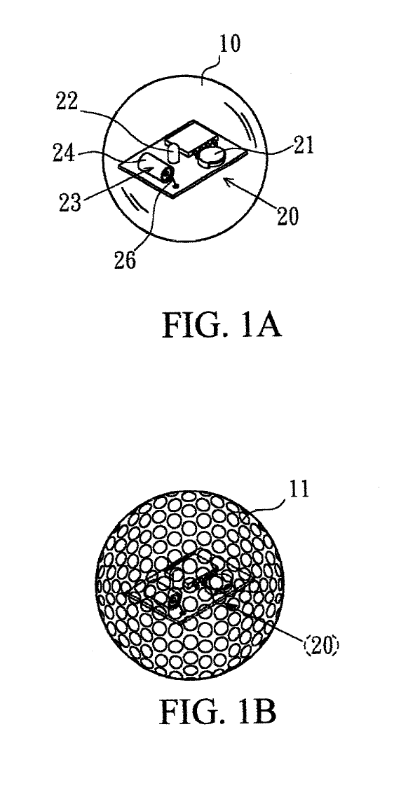

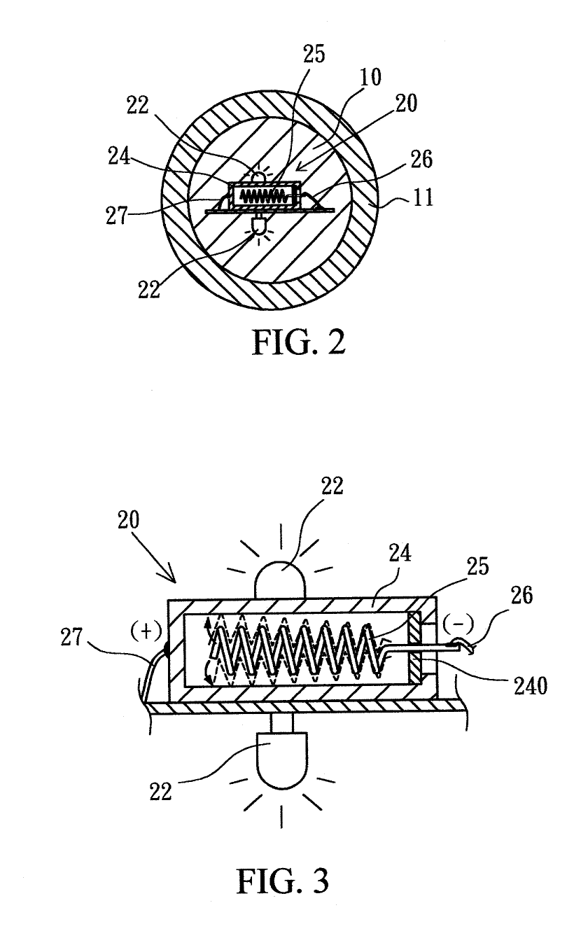

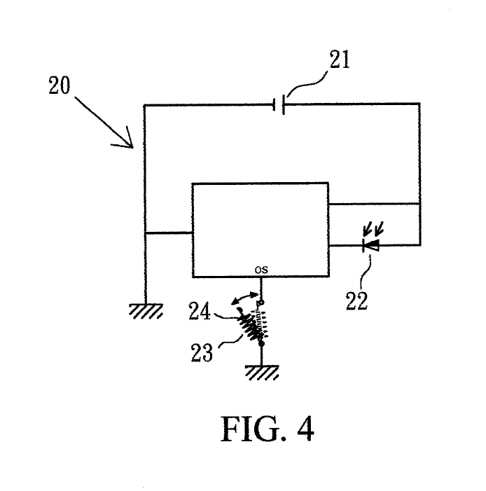

### DETAILED DESCRIPTION OF THE PREFERRED EMBODIMENT

Referring to FIGS. from 1 through 4, a light emitting golf ball is shown comprised of an outer shell 11 that admits light, a core 10 embedded in the outer shell 11, the core 10 admitting light, and a light emitting circuit assembly 20 embedded in the core 10. The light emitting circuit assembly 20 comprises a battery 21 that provides the necessary working voltage, a plurality of LEDs (light emitting diodes) 22, and an impact switch 23 electrically connected between the battery 21 and the LEDs 22. The impact switch 23 is comprised of a metal casing 24 and a metal spring 25. The metal casing 24 is connected to one terminal, for example, the positive terminal of the battery 21 by a conductor 27. The metal spring 25 is suspended inside the metal casing 24, having one end inserted through an electrically insulative pad 240 in the metal casing 24 and connected to the other terminal, namely, the negative terminal of the battery 21 by a conductor 26.

Referring to FIGS. from 2 through 4 again, when carrying the light emitting golf ball or holding it with the hand, the vibration force is insufficient to vibrate metal spring 25 violently. At this time, the metal spring 25 does not touch the metal casing 24, and therefore the impact switch 23 is off. When the user hits the light emitting golf ball with the club, the heavy impact forces the metal spring 25 to vibrate violently, thereby causing the metal spring 25 to contact the inside wall of the metal casing 24 intermittently. When the metal spring 25 touched the inside wall of the metal casing 24, the impact switch 24 triggers the control IC of the light emitting circuit assembly 20, causing the control IC of the light emitting circuit assembly 20 to flash the LEDs 22 subject to a predetermined flashing mode for a predetermined length of time.

When driven the light emitting golf ball into the air in the night, the light emitting golf ball flashes, like a line of light passing over the sky. Because the control IC of the light emitting circuit assembly drives the LEDs 22 to flash or to emit light for a predetermined length of time when triggered by the impact switch 24, the user can see the light emitting golf ball in the dark from a distance.

Further, the outer shell 11 and the core 10 are made of plastics that provide sufficient resilient strength and, meet standard golf specification requirements. Because the light emitting circuit assembly 20 is embedded in the core 10, it is positively positioned in the light emitting golf ball. Impact of the light emitting golf ball does not cause the light emitting circuit assembly 20 to displace.

Although a particular embodiment of the invention has been described in detail for purposes of illustration, various modifications and enhancements may be made without departing from the spirit and scope of the invention. For example, bristles may be separately installed in the periphery of the ball body and spaced from one another at an equal pitch.

What the invention claimed is:

1. A light emitting golf ball comprising a plastic outer shell that admits light, a plastic core embedded in said outer shell, said plastic core admitting light, and a light emitting circuit assembly embedded in said core, said light emitting circuit assembly comprising a battery, a plurality of LEDs (light emitting diodes), and an impact switch electrically connected between said battery and said LEDs and adapted to turn on said LEDs upon an impact, said impact switch comprising a metal casing connected to one terminal of said battery, and a metal spring suspended in said metal casing and electrically connected to an opposite terminal of said battery.
